(19) United States
(12) Patent Application Publication
(10) Pub. No.: US 2009/0254934 A1
(43) Pub. Date: Oct. 8, 2009

(54) Listener Contributed Content and Real-Time Data Collection with Ranking Service

(76) Inventor: Justin L. Grammens, Minneapolis, MN (US)

Correspondence Address: MERCHANT & GOULD PC, P.O. BOX 2903, MINNEAPOLIS, MN, 55402-0903, US

(21) Appl. No.: 12/418,244

(22) Filed: Apr. 3, 2009

Related U.S. Application Data
(60) Provisional application No. 61/041,984, filed on Apr. 3, 2008.

(51) Int. Cl. H04H 60/32

(52) U.S. Cl. 725/14; 725/24

(57) ABSTRACT

A computing device includes a processor and memory. The memory encodes instructions that, when executed by the processor, cause the processor to create: a first module programmed to allow consumers to push content into a distribution channel and share feedback of broadcasted media by voting and sharing feedback; a second module programmed to automatically suggest adjustment of programming of a media center based on the feedback from the consumers; a third module programmed to identify current demographic information of the consumers that are listening to media and giving feedback, and to automatically suggest adjustment of the programming of the media center based on the demographic information; a fourth module programmed to monitor the consumers' action information, including actions of turning the media on or off, or changing to another media, and automatically suggest adjustment of programming of a media center based on the action information.

### BACKGROUND

For radio and television stations to survive they must be open to the public regarding feedback of the content that they broadcast. The current methods include listeners or viewers calling or writing the station to express their opinion about the content that is being broadcast. In this situation the consumer must trust that their message was not only received by the appropriate person at the media outlet, but also that their views are taken into consideration for future programming. The consumer is also hidden from the process by which new media is chosen and future programming developed. Therefore, the consumer of the media only has the alternative to turn the station on if they like it or to turn it off if they dislike it.

Some efforts have been made to collect user data (Nielsen Ratings), but this method is flawed and very expensive. The user does not have direct feedback with the broadcaster and you are not opening the ability up to ALL of the consumers of the media. You instead have a small sample. Likewise, some media stations allow for users to contribute their content to the station by providing a “submit your talent” feature to their website for instance. The problem with this method is that there is no true way for the person who submits the content to know that the community of other contributors are aware that he/she has contributed, or even more important, the other members of the community have no methods by which they can vote or rate the content that has been submitted to have it added to the existing library owned by the broadcaster.

Some problems that exist with current systems include one or more of the following.
Current broadcasting is all PUSH technology.
No centralized systems to generate metrics on what media consumers really want.
No method for advertisers to know what people actually like and dislike about a certain commercial other than a sample polling audience.
No method for a viewer or listener of a station to see the popularity of all of the media in a station's library.
No method for a consumer of the content to see how others consuming the content are raking the media and be able to see the ranking adjust in real-time.
No method for the average viewer or listener to contribute their video or audio to the station and get feedback from the station's community on the quality of their content.
Expensive to do lots of sample polling via phone calls and rating systems.
No method to implicitly adjust the broadcast in real-time, based on the listening demographic during specific times of the day.
No method to track when a user changes the station or change from one song to another in their playlist.
Even if you are able to collect sample data, there exists no good way to intelligently rank and select the order the media is to be broadcast based on user's input.

Additionally, media stations don't have a reliable method to learn about their consumers. For example, many systems can claim to rank a certain piece of media based on input from listeners, but questions soon arise revolving around how does the system “break the tie” when media has been voted on equally by a group? How do you really provide for smart media selections for the community? Current primitive methods exist that could include tracking the number of times media is voted on and incrementing a counter when it's voted up and decrementing a counter when it's voted down. The media with the higher count wins. The problem with this method is that very often you will find media with the same number of votes. Also, it's quite possibly the case where raking is affected by someone who is just out to sway or spike the pole by always only voting for one particular media item. These types of voters are only out to push their band to the top and not listen to anything else. Therefore, pure vote tallying has flaws:
More prone to media having the same number of up and down votes (tie).

Voters voting who don't have any knowledge or history with the community.

Voters voting to better further their own personal media, not media that is good.

Computerized methods by which a malicious computer program would just login once a day and vote on media and not listen to what is being broadcast.

### SUMMARY

The system described herein allows a media station more access to the consumers who are enjoying their station, by allowing the consumer the ability to push their content into the distribution channels and share their feedback of broadcasted media by voting up or voting down and optionally sharing feedback about their decision. This entire process is transparent in which any listener can visually see the actions going on in the system via a website widget, an RSS feed or email response. Optionally, the consumer can dial a phone number and vote and be spoken to by the system over the phone to tall them what is popular.

While votes are being cast, the media outlet then has the opportunity to adjust its programming as little or as much as they wish based on this collected data. Adjustments to station's programming can be varied, where the system is completely automated and the most popular content is broadcast first, to one in which there is manual process of review before being broadcast. The control is up to the broadcaster and they can choose to give up as little or more control to the listeners as they choose.

Additionally, the system will inform the station real-time on the current demographic that is both listening and giving feedback. If little or a small number of votes are being cast, intelligent decisions based on demographic information of the consumer are applied and listeners who haven't even voted gain in the strength of the station playing content that appeals to the same listening demographic at that particular time of the day. As the day progresses, the listening demographic will change and thus the system will more intelligently program the media to what its consumers want.

The system also has the ability to watch a specific user's actions. Based on their actions of turning the song on or off, or changing to another song and listening for a longer period, inferences are made on what the user likes and dislikes and changes made directly to the station's programming.

The system therefore fills a distinct void in this market by providing more detailed data to broadcasters and advertisers of their consumers and help in building an increasingly loyal community of listeners and viewers. It's able to provide intelligent programming based on listener's demographics and interactions with the system. It does all of this by providing transparency to the community of who is contributing and voting on the content, which includes any type of media.

Finally, media consumers are constantly looking for that station that “just knows what I like.” With the consumer able to vote, they will be signed on with the system and will have provided demographic information in their profile. With this knowledge of who is listening, the station is able to infer the type of media content that would be appropriate for their consumers at that specific time of the day. Stations might have one demographic in the morning and another in the evening. With data from user's being signed on to the system, the station is now able to make intelligent programming decisions based on the demographic of its listeners at that specific point in time. Likewise, the physical actions that the consumer takes can be just as important. If a user consistently turns off a song or changes to another station, decisions can be made on what their likes and dislikes, and over time using demographic information, a station will be much more intelligent at catering directly to the needs of its listeners and viewers.

### DESCRIPTION OF FIGURES

FIG. 1 is an overall high-level system architecture diagram showing all of the major players in the system in a broadcast radio scenario.

FIG. 2 is an internal view of how the system processes the feedback it is being sent from the listeners.

FIG. 3 is a view of how a user might utilize a small widget on a website to vote with the system. In this example it is a radio station.

FIG. 4 is a view of how a user adds new content into the system.

FIG. 5 is a view of how a broadcaster accesses their media on the system through their browser.

FIG. 6 is a view of how a broadcaster accesses the data in the system through their existing radio programming software.

FIG. 7 is a flowchart of how the feedback process works within the system.

FIG. 8 is a diagram showing how a user might interface with the service using their cell phone or any plain old wall or desk phone.

FIG. 9 is a diagram of how an advertiser would interact with the system to compare both historical and real-time data of what users are voting on their commercials and other media around their commercial.

FIG. 10 is a diagram of the system showing the next media title that should be broadcast based on the demographic information from the current users active in the system.

FIG. 11 is a diagram showing the ranking of media in the system.

### DETAILED DESCRIPTION

Embodiments disclosed herein do not store the actual data to be voted on, but the metadata information (artist, release, title, etc.) of the media from the station's library. Consumers of the media then have an opportunity to give feedback on the content by voting a title up or down. In addition to media information, the popularity of each item in relation to one another, time of day, geographic location of when a vote was cast and demographic profile information of the user who voted on the said content is stored. The system allows playlist adjustments for content providers, mining of this the data for advertisers and users to see current ranking of the media in real-time. Broadcasters can use this current ranking method to adjust their playlist immediately or at a future date. Because Broadcasting and receiving data over a network such as the Internet allows for tracking and storage of listener's and viewer's actions, the system is able know precisely when the user changed the station and what they changed their station to. As one example, the system provides real-time adjustments of the popularity of media garnered from what listeners are voting on and show it on a website widget, such that everyone is able to see what listeners contributed to the voting totals. Transparency and intelligent programming decisions based on both implicit and explicit actions is one cornerstone of the system.

The system allows access to the broadcaster's metadata of their entire media playlist by providing an API interface to allow them to find out information regarding the popularity and feedback of this media based on input from viewers and listeners. The system is what is termed a “Web Service” and is accessible via the Internet using a common Internet API architecture principal called REST.

The main features of this API that are provided to the broadcasters, advertisers and consumers are:
The ability for a broadcaster to add, delete and edit the metadata about their media in the system.
The ability of anyone to vote on media in the system via any digital medium (web, email, SMS, MMS, and phone)
Ability to categorize which data is more or less popular in relation to each other.
The ability for the provider of advertisements to mine voting data with the purpose of generating charts and graphs to see what time of the day more songs are popular, what commercials are popular and gauge the interest of their listening market. Voting occurs on any piece of content in the system—commercials included.
The ability for anyone to upload media into the station where the community can vote in a private area on the content before it's allowed to be put into rotation by the broadcast director. It therefore allows for not only voting on existing media for the station, but new media submissions.
Decisions on future broadcasting based on the consumer's implicit actions. For example, adjustments to the playlist based on the fact that a particular consumer tuned into a different radio station at this time of the day or the fact that another consumer always changes the channel when a particular DJ is on.

In regards to the questions of who, what, when, where and why, the system gives real-time data related to voting by providing the media outlet with following critical pieces of information about their listeners in a way to improve profitability. This is very important data to the station and gives this system its commercial viability. The station gains the following critical pieces of information:
WHO (The phone number/demographic profile of who is voting. Must provide some type of user information to setup an account and be logged in.)
WHAT (The media they are currently listening to or voting on.)
WHEN (The time and date of when they are voting and listening to the media.)
WHERE (GPS—where the consumers are listening and voting on the media from using cell phone triangulation.)
WHY (What it is about the audio that they like/dislike. Allows for the user to explain why they voted up of voted down this media.)

Beyond the feedback to the broadcasting station as described herein, the system provides transparency to the consumers of what people are enjoying (or not enjoying) by showing the votes as they arrive in a real-time fashion. Because of this transparency, the listeners and viewers have a much greater vested interest and loyalty to the media outlet as they feel that they actually have a voice in the community of consumers. The fact they can give a response and have it known not only to the other listeners and viewers, but the broadcast station is monitoring the current rankings, gives the feeling that they have control.

One aspect of the system besides data collection and user contribution is intelligently ranking the media. The system is more intelligent than a simple counter and solves this problem of malicious users and how one would break a tie vote for particular media.

In the system at any particular point in time, a piece of media and a user has a specific ranking number. This ranking number is created from a number of different factors, that are influenced by the votes for up and down, but many other relationships are at play in terms of generating that ranking number both for media and for user's based on prior voting history. The factors that have a positive impact on the data within this system to create the ranking order include:
When the song was most recently voted on.
   The more recent a vote was cast the more relative to the system and current the vote is.
Media voted on by users who vote on a wide range of media.
   Users who vote on media by other artists show that this user is spreading their votes around and are less about affecting one artist or media file.
Media voted on by wide range of users.
   Media that has been voted on not only more times, but by a wider distribution of consumers is a stronger candidate for a higher ranking.
How long the users who vote on this media that have been listening to the system.
   Users that are signed on and listening to the system for a longer amount of time are more involved in the community of media and thus have a strong commitment to keep the media good in the system. Votes cast by these users are given a greater weighting.
How many media files in the system the person has heard/viewed.
   If a person who has consumed a lot of the other audio in the system casts a vote, the assumption is that they have more data to compare it their selection to. This gives the vote more impact as the voter is making a more intelligent decision.
Voted on by the users who didn't contribute the media.
   If you contribute the media and then vote on it, your votes will not have as strong an effect as someone you don't know voting on your media.
Number of times the media was voted on by the same user.
   Media that only have 1 voter voting on them are not held in high regard and do not rank well in this system.
Use “captcha” to stop automated voting
   Captcha is a system by which one can verify the person making the submission is a human by forcing them to spell a word or perform some logic when casting their vote.
Voting totals
   Finally, at the very bottom of the comparison is the number of votes a particular piece of media receives. The “popular vote” on media files is still counted, but it's held in a lower regard when in conjunction with all of the other metrics to create our ranking score.

At the time a request is made to either show the current ranking of media in the system or to return to the caller the next media that should be used in a particular stream, all of these selected features are taken into account with configurable weights and measures being done depending on the metrics set our by the broadcaster using the system. These additional metrics prove much more reliable and result in raking and playlist generation that is a true reflection of the community.

On a whole, the community of listeners benefits by honest votes from users who are active on the system by voting on a while range of media. The system provides this fair and balanced approach where one person cannot hijack the process and send the community in a direction that it does not wish to go.

Because this system uses the Internet and common API's, existing media station software (radio stations for example) can integrate with the system very easily. Take taking radio for example: Radio station program directors have the ability to choose to have as much or as little impact as they would like the community to have on their station. From one song an hour to one song a day, to anywhere in between, the station director can control what is being fed to the radio station programming software. Since the system uses common Internet protocols and API's, it integrates easily with existing software applications and no new media programming software system needs to be learned. Radio is just one example, there is nothing stopping this same method to be used by television program directors using their already purchased, in-house scheduling software as well.

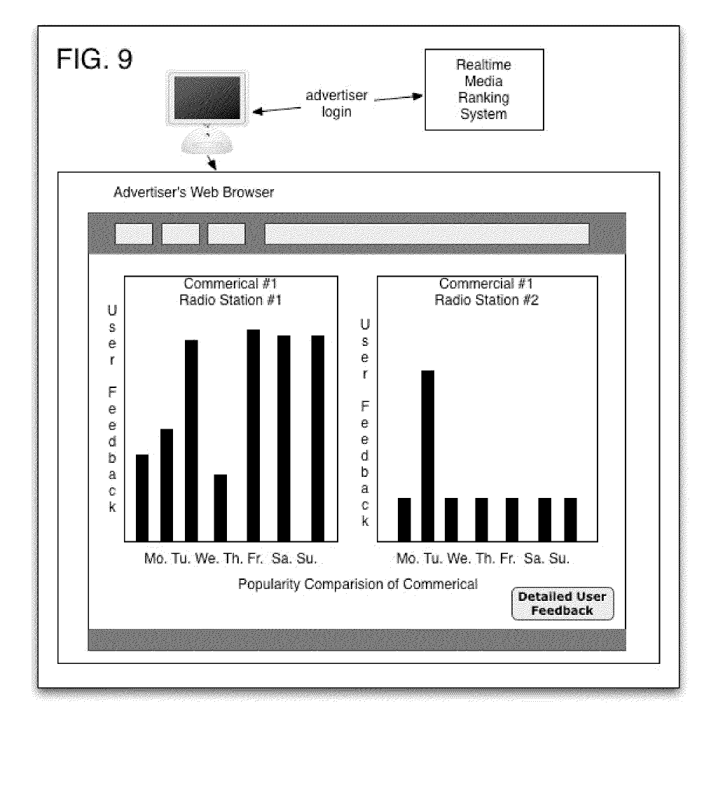

All users who vote must have an account in the system. The system provides a simple method for a user to signup and create his or her own personal profile, which contains all of the data about the user that the station is interested in collecting. This profile is reused across all media outlets. This is convenient, but also very powerful. This means that the user does not need to login again if they are voting through two separate stations that use the system. More importantly however, the data is stored in one location and could be compared across station to station if so desired by the advertiser. For example, an advertiser might have a commercial with two radio stations and wants to know which one is gaining better response. The commercial company could get real-time data from the system on the differences between the same commercial being played on two different stations in possibly two distinct markets. This would prove important when it comes time to decide where they will spend future advertising dollars. (FIG. 9)

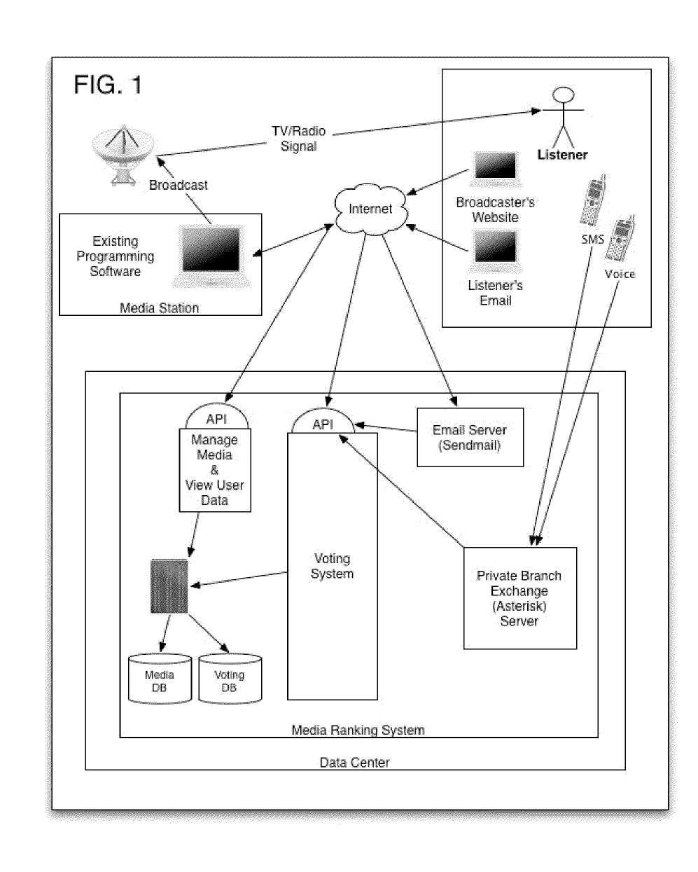

After being registered by the system, the user is able to vote on media in a number of different fashions. (FIG. 1)
Web—User visits the station's website, and votes on a particular piece of content either UP or DOWN. They are given a method to give more feedback about the media as well.
SMS—User texts messages UP or DOWN to a specific phone number and are given the opportunity to give more feedback on the media in their message.
Voice—User dials a phone number, is told the current media being played and presses 1 to vote up 2 to vote down. The user is then told the current rank of the song they just voted on. They are then given the opportunity to speak additional feedback information if they so desire.
Email—User sends and email with the subject line of UP or DOWN to predefined email address along with additional textual feedback on the media in the message body. The user receives a response that their vote was counted and link and summary information on current raking.

To provide against too much control, each user is allotted a defined number of votes per day and ultimately, the media station has as much or as little control as they want as to how much of an impact this voting data will have on their broadcast. At any time a user is able to go to a broadcaster's website and see the current ranking and both when and who has last voted on this media. What makes this service unique and different is that this ranking is updated in real-time as the votes are being processed. Additionally, this service works over plain old telephone networks as many listeners don't have an Internet connection or possibly have visual impairments that make using the Internet difficult. It's important to note, that the system allows the user to interact with the media by using any plain old phone to contribute their feedback into the system.

A few real world applications are as follows.

Radio Broadcaster: An FM radio station would like to get real-time feedback from its listeners as to what audio tracks (commercials included) are popular. While a piece of audio is being played, a listener who has registered sends a text message of UP or DOWN to 80123. This information is sent to the service where we record the response and who made this request (using their phone number to tie them to a user in the system). The radio station's programming software then makes a request to our service when it comes time to play the next song and will take this voting information into account as to if it should play the audio segment or not. This is all strictly automated and occurs with communication over the Internet using the existing software radio stations are familiar with and use today.

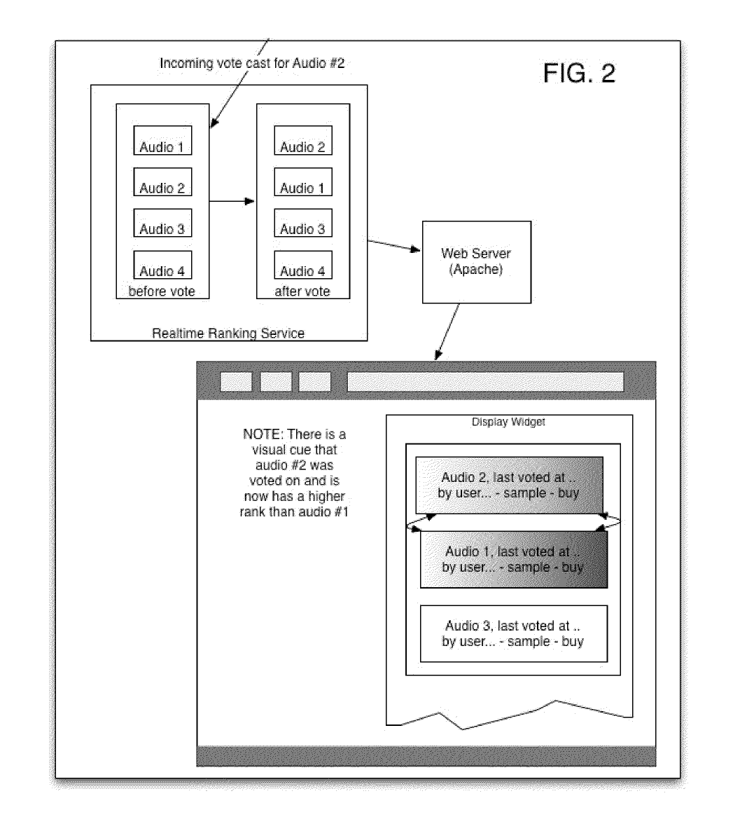

Television Broadcaster: A television station would like to bring more viewers to its website and build a greater online presence. They put a system provided “widget” (FIG. 2) piece of HTML code into their website. The widget allows visitors to the website to vote either up to down on the program being broadcast on the television's terrestrial broadcast signal. Visitors to the website can see their vote being counted from within this widget. This provides more traffic to the television station's website and users are much more loyal to the station seeing their vote impacting the content.

Advertiser: An advertiser is interested in learning what station would make the most sense for them to advertise their product with. They decide to put the same commercial on two different radio stations and look at real-time voting data (FIG. 9). After a certain period of time, the company is able to see what feedback listeners have given, either on the content directly (explicit), or the feedback that listeners have given to the content played around their commercial (implicit), with the thought being that negative feedback for other media around their commercial, would most likely result in their commercial having less impact. The advertiser is able to view charts and hard numbers to base advertising dollars on which station what the consumers they should be targeting.

Listener: A listener hears “Let it Be” by The Beatles on a radio station and really enjoys Paul McCartney's voice and harmonies. The listener would like to give feedback in the hopes that it would be played again at some point in the future. The listener types in the word “UP” and send a text message to the radio station's feedback designated phone number for the system. The system returns with a message of “Your vote has been successful. Please text any additional feedback you would like on this media.” The user texts back to radio station “I really like Paul's voice and harmonies from this era. Please add the song “Come Together” to your playlist as well.”

FIG. 1 is an overall high-level system architecture diagram showing all of the major players in the system in a broadcast radio scenario. It covers everything regarding the interaction of the radio station, to the listeners and the votes that signal the completion of the entire feedback loop. This diagram shows that user is able to use a website, SMS, email or phone their vote into the system.

FIG. 2 is an internal view of how the system processes the feedback it is being sent from the listeners. It shows the steps of what happens, both internal to the system and what is being viewed from the outside when a vote is tallied. Most importantly it shows that the ranking of the media changes in real-time and is projected in the display widget on the station's website.

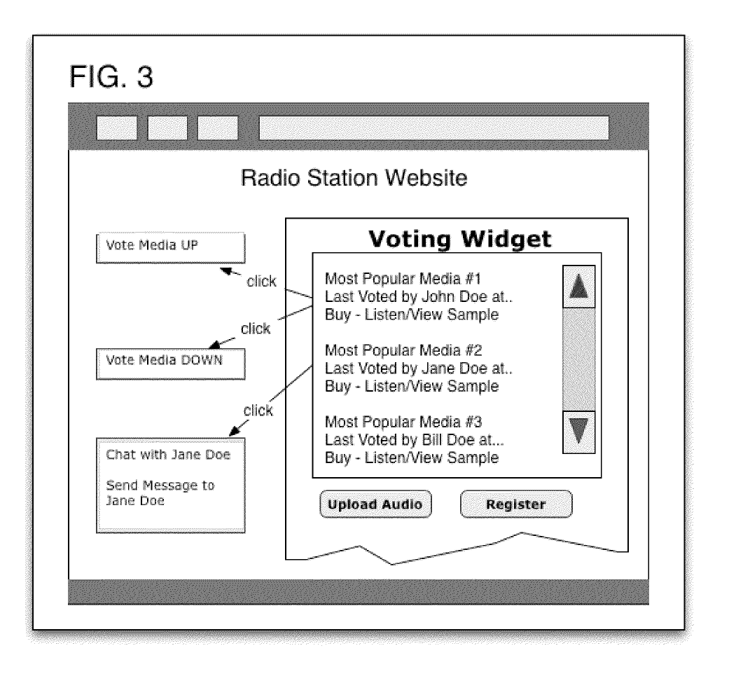

FIG. 3 is a view of how a user might utilize a small widget on a website to vote with the system. In this example it is a radio station. The user is able to see a listing of the audio in the system and its current rank. They can also see who has been voting on this audio and are able to link off to purchase audio by the artists or sample any of the audio before voting it up or voting it down. The system also includes some social aspects of allowing listeners to connect and send messages to one another.

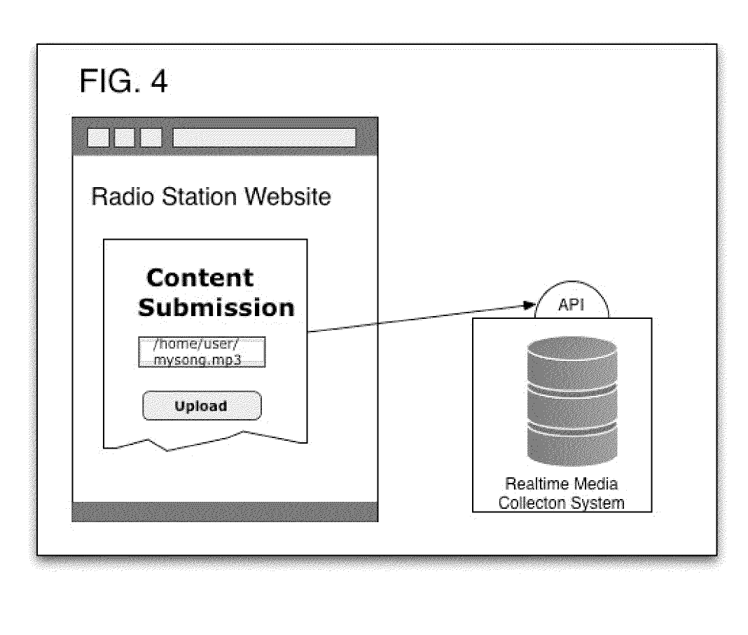

FIG. 4 is a view of how a user adds new content into the system. The content can be added directly from the media station's website by either the stations program director or if the station so chooses, to open it up and allow any registered to contribute their content into the system.

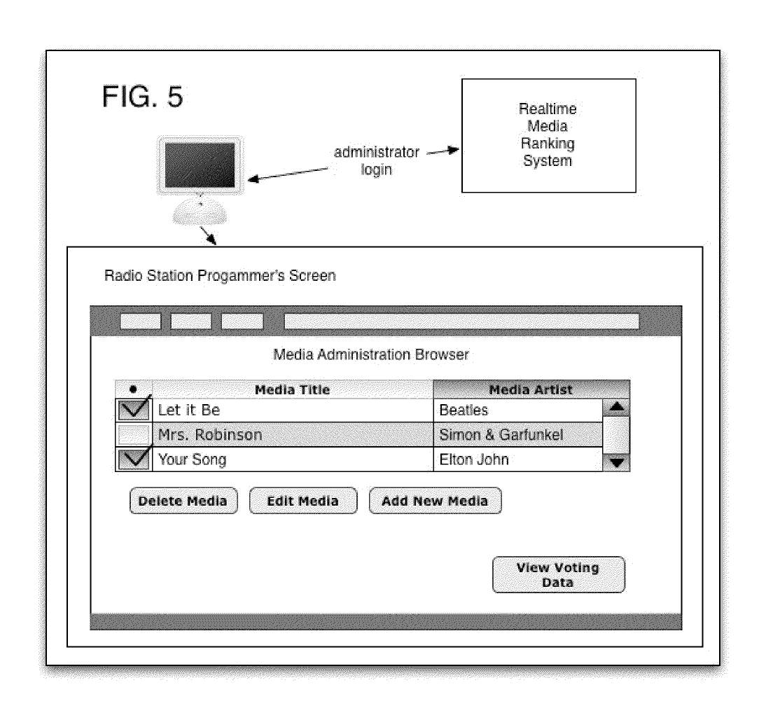

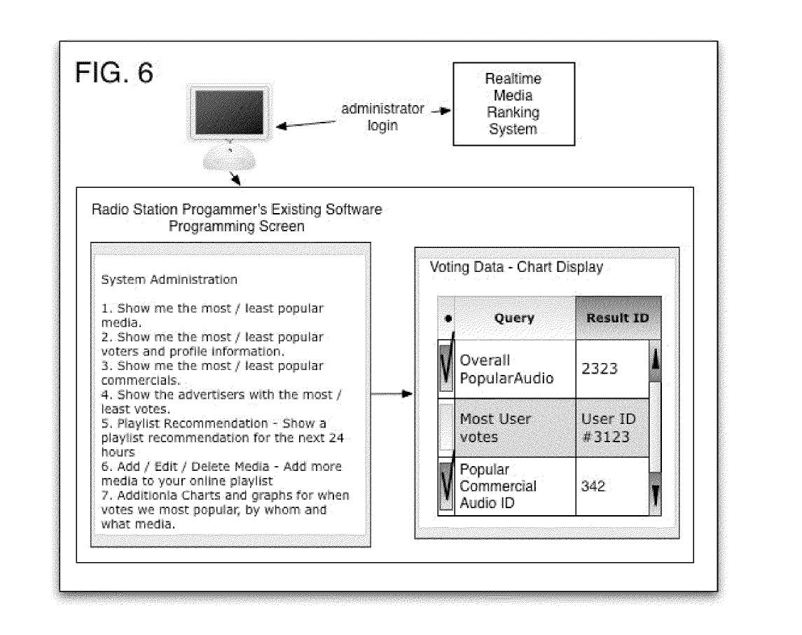

FIG. 5 is a view of how a broadcaster accesses their media on the system through their browser. The radio station program director is able to login to the system and see a listing of their media. They are able to add, edit and delete media, but more importantly, they have a link where they can view the voting data, which will take them to a view similar to FIG. 6.

FIG. 6 is a view of how a broadcaster accesses the data in the system through their existing radio programming software. Because the system is a web service API, the program director can access the users voting history and information either through a web browser, or their existing program scheduling software. They are able to see among other useful data, what is popular, who is voting, what the system would suggest as future media. All with very easy to understand chart and graphing capabilities.

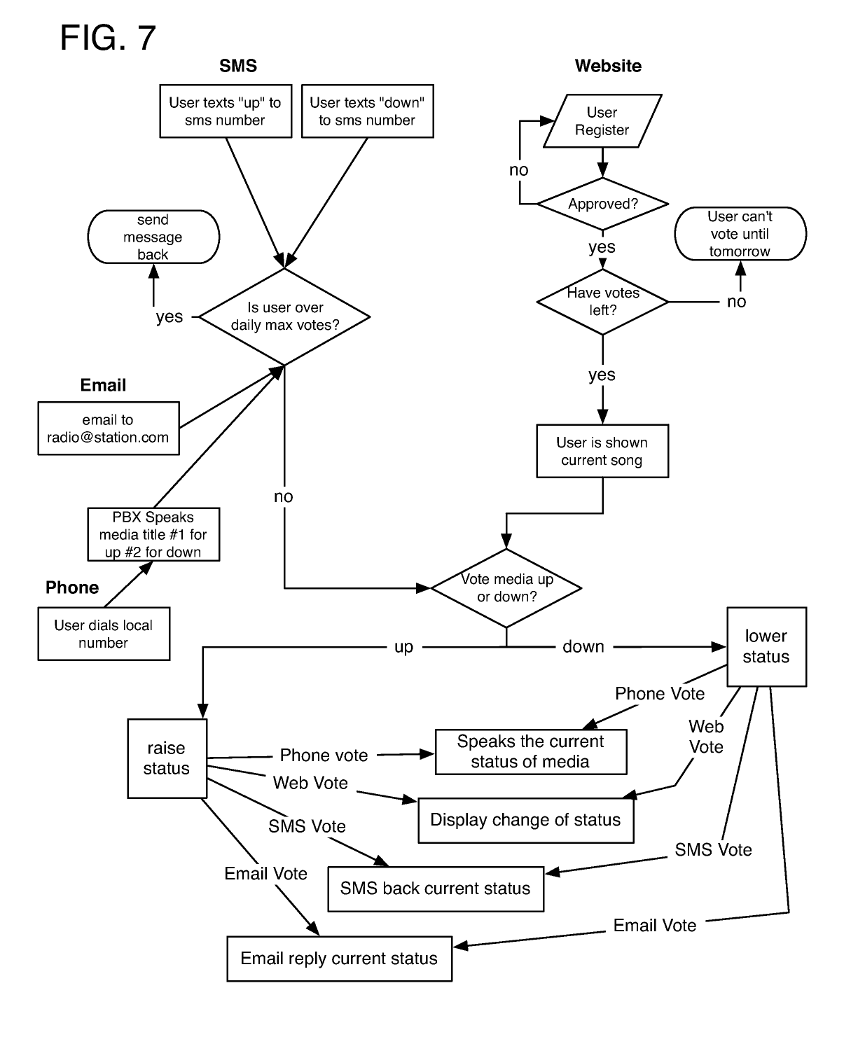

FIG. 7 is a flowchart of how the feedback process works within the system. This figure shows all of the various methods by which a user can give feedback into the system and responses by the system along the way. The system needs to know whom the user is to deduct their daily vote count and it does this by their profile. Their profile has an associated phone number (SMS and phone voting), email address (email voting) and web based Internet voting (username and password sign-on).

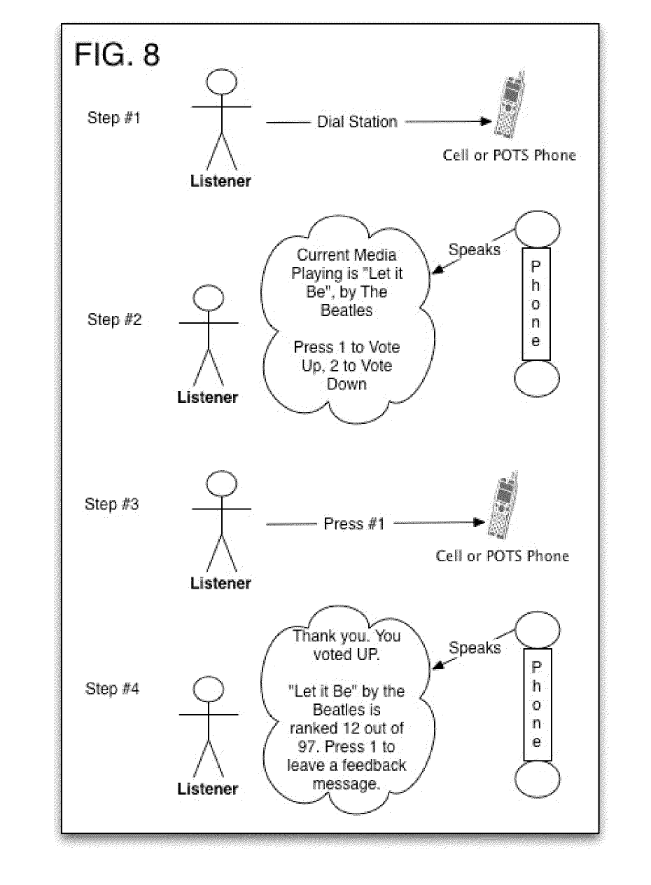

FIG. 8 is a diagram showing how a user might interface with the service using their cell phone or any plain old wall or desk phone. The user dials the phone number and the system speaks to them the current media title and asks them to press 1 to vote up, 2 to vote down. After the selection is made the system responds letting them know that their vote was counted, the current ranking of the media and asks if they would like to leave additional voice feedback about the media for the station.

FIG. 9 is a diagram of how an advertiser would interact with the system to compare both historical and real-time data of what users are voting on their commercials and other media around their commercial. This shows the advertiser data on what stations they should spend advertising dollars with in the future and which most stations they should revisit running their advertisements with.

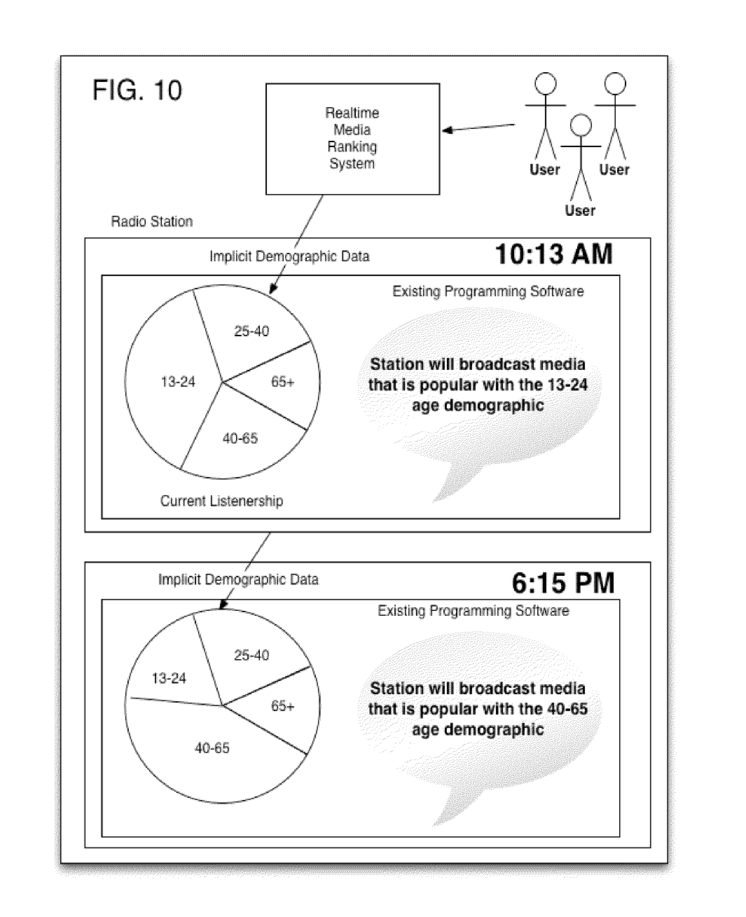

FIG. 10 is a diagram of the system showing the next media title that should be broadcast based on the demographic information from the current users active in the system. There aren't any votes going on in the system, but based on previous voting patterns and users that are logged into the system, assumptions can be made using implicit data on what media should be broadcast.

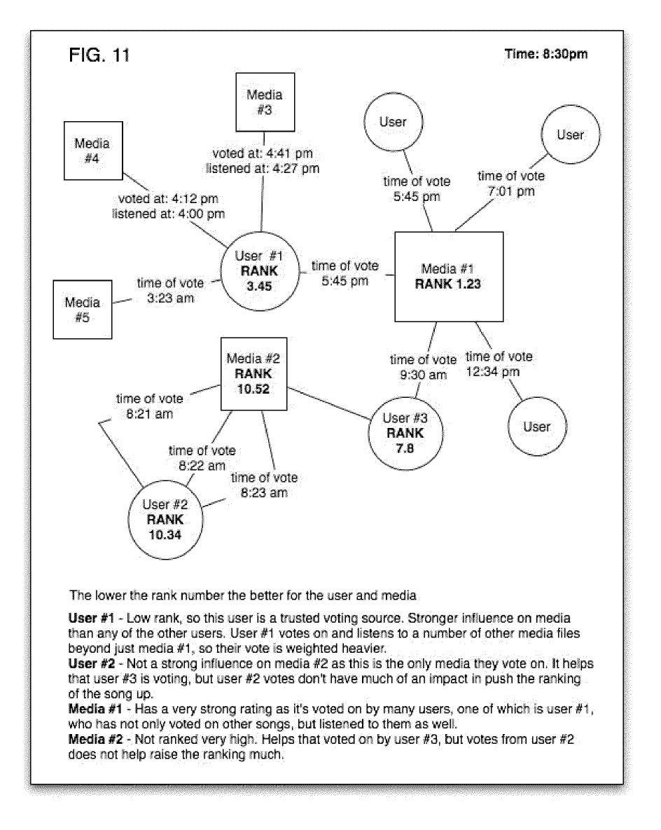

FIG. 11 is a diagram showing the ranking of media in the system. It shows that certain users have a stronger impact based on their voting and listening history and the time at which the votes were cast. The lower the ranking number the stronger the popularity of the media and the user's voting power.

As the system is an Internet web-service, all of the media and voting data can be accessed through a web browser, existing software, desktop widget, etc. Any piece of software that has access to the worldwide web and the correct credentials is able to access this data. There is no dependence on the client software or operating system. It can be accessed via existing software (provided the original software manufacturer implements the API), a standard web browser or a simple desktop widget to allow for display and interfacing with the system.

The example systems described herein may include one or more electronic computing devices. An electronic computing device comprises a memory unit. The memory unit is a computer-readable data storage medium capable of storing data and/or instructions. The memory unit may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, the electronic computing device comprises a processing unit. As mentioned above, a processing unit is a set of one or more physical electronic integrated circuits that are capable of executing instructions. In a first example, the processing unit may execute software instructions that cause electronic computing device to provide specific functionality. In this first example, processing unit may be implemented as one or more processing cores and/or as one or more separate microprocessors. For instance, in this first example, processing unit may be implemented as one or more Intel Core 2 microprocessors. The processing unit may be capable of executing instructions in an instruction set, such as the x86 instruction set, the POWER instruction set, a RISC instruction set, the SPARC instruction set, the IA-64 instruction set, the MIPS instruction set, or another instruction set. In a second example, the processing unit may be implemented as an ASIC that provides specific functionality. In a third example, the processing unit may provide specific functionality by using an ASIC and by executing software instructions.

The electronic computing device also comprises a video interface. The video interface enables the electronic computing device to output video information to a display device. The display device may be a variety of different types of display devices. For instance, the display device may be a cathode-ray tube display, an LCD display panel, a plasma screen display panel, a touch-sensitive display panel, a LED array, or another type of display device.

In addition, the electronic computing device includes a non-volatile storage device. The non-volatile storage device is a computer-readable data storage medium that is capable of storing data and/or instructions. The non-volatile storage device may be a variety of different types of non-volatile storage devices. For example, the non-volatile storage device may be one or more hard disk drives, magnetic tape drives, CD-ROM drives, DVD-ROM drives, Blu-Ray disc drives, or other types of non-volatile storage devices.

The electronic computing device also includes an external component interface that enables the electronic computing device to communicate with external components. The external component interface enables the electronic computing device to communicate with an input device and an external storage device. In one implementation of the electronic computing device, the external component interface is a Universal Serial Bus (USB) interface. In other implementations of the electronic computing device, the electronic computing device may include another type of interface that enables the electronic computing device to communicate with input devices and/or output devices. For instance, the electronic computing device may include a PS/2 interface. The input device may be a variety of different types of devices including, but not limited to, keyboards, mice, trackballs, stylus input devices, touch pads, touch-sensitive display screens, or other types of input devices. The external storage device may be a variety of different types of computer-readable data storage media including magnetic tape, flash memory modules, magnetic disk drives, optical disc drives, and other computer-readable data storage media.

In addition, the electronic computing device includes a network interface card that enables the electronic computing device to send data to and receive data from an electronic communication network. The network interface card may be a variety of different types of network interface. For example, the network interface card may be an Ethernet interface, a token-ring network interface, a fiber optic network interface, a wireless network interface (e.g., WiFi, WiMax, etc.), or another type of network interface.

The electronic computing device also includes a communications medium. The communications medium facilitates communication among the various components of the electronic computing device. The communications medium may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The electronic computing device includes several computer-readable data storage media (i.e., memory unit, the non-volatile storage device, and the external storage device). Together, these computer-readable storage media may constitute a single data storage system. As discussed above, a data storage system is a set of one or more computer-readable data storage mediums. This data storage system may store instructions executable by the processing unit. Activities described in the above description may result from the execution of the instructions stored on this data storage system. Thus, when this description says that a particular logical module performs a particular activity, such a statement may be interpreted to mean that instructions of the logical module, when executed by the processing unit, cause the electronic computing device to perform the activity. In other words, when this description says that a particular logical module performs a particular activity, a reader may interpret such a statement to mean that the instructions configure the electronic computing device such that the electronic computing device performs the particular activity.

What is claimed is:

1. A computing device, comprising:
a processor; and
a memory encoding instructions that, when executed by the processor, cause the processor to create:
a first module programmed to allow consumers to push content into a distribution channel and share feedback of broadcasted media by voting and sharing feedback;
a second module programmed to automatically suggest adjustment of programming of a media center based on the feedback from the consumers;
a third module programmed to identify current demographic information of the consumers that are listening to media and giving feedback, and to automatically suggest adjustment of the programming of the media center based on the demographic information; and
a fourth module programmed to monitor the consumers' action information, including actions of turning the media on or off, or changing to another media, and automatically suggest adjustment of programming of a media center based on the action information.
